(19) United States
(12) Patent Application Publication
(10) Pub. No.: US 2022/0144074 A1
(43) Pub. Date: May 12, 2022

(54) HYBRID POWER SYSTEM

(71) Applicant: Schaeffler Technologies AG & Co. KG, Herzogenaurach (DE)

(72) Inventor: Zhihao LI, Shanghai (CN)

(21) Appl. No.: 17/435,186

(22) PCT Filed: Mar. 1, 2019
(86) PCT No.: PCT/CN2019/076700

§ 371 Date: Aug. 31, 2021

(51) Int. Cl. B60K 6/547; B60K 6/36; B60K 6/387; F16H 3/091; B60K 6/44

(52) U.S. Cl. CPC B60K 6/547; B60K 6/36; B60K 6/387; F16H 2200/0078; B60K 6/44; B60Y 2200/92; F16H 3/091

(57) ABSTRACT

A hybrid power system is provided having a motor, a double clutch, and a transmission with three synchronous meshing mechanisms, the hybrid power system can, through a reasonable structural design, implement the same as or more than the number of gears and operating modes of hybrid power systems employing a single motor and a dedicated hybrid transmission in the prior art, while being simpler in structure, more compact in size, and less costly.

### CROSS-REFERENCE TO RELATED APPLICATIONS

This application is the U.S. National Phase of PCT Appln. No. PCT/CN2019/076700, filed Mar. 1, 2019, the entire disclosures of which is incorporated by reference herein.

### TECHNICAL FIELD

The present disclosure relates to the field of vehicles, in particular to a hybrid power system.

### BACKGROUND

In the prior art, a strong hybrid power system or plug-in hybrid power system may comprise a single motor and a dedicated hybrid transmission, which makes the hybrid power system flexible and highly modular.

As an example of a hybrid power system comprising a motor and a dedicated hybrid transmission as described above, there exists a hybrid power system having the following structure, which comprises an engine, a motor, a transmission comprising five synchronous meshing mechanisms, a single clutch located between the engine and the motor and a double clutch located between the motor and the transmission, the output shaft of the engine being in transmission connection with an input/output shaft of the motor via the single clutch and the input/output shaft of the motor being in transmission connection with an input shaft of the transmission via the double clutch.

The hybrid power system has a complex structural design, given that it has a single clutch and a double clutch with two clutch units, and five synchronous meshing mechanisms are arranged inside the transmission. This will result in larger effort and higher cost to integrate the components of the hybrid power system, and will also result in larger sizes of the modules of the integrated hybrid power system, thereby making the overall layout containing the hybrid power system even larger.

As another example of a hybrid power system comprising a motor and a dedicated hybrid transmission as described above, there also exists another hybrid power system having the following structure, which comprises an engine, a motor, a transmission comprising four synchronous meshing mechanisms and a single clutch located between the engine and the transmission, the output shaft of the engine being in transmission connection with a first input shaft of the transmission via the single clutch and the input/output shaft of the motor being in transmission connection with a second input shaft of the transmission via a gearwheel transmission mechanism.

Although such hybrid power system comprises only one clutch, the transmission has four synchronous meshing mechanisms arranged inside, and the transmission further comprises a reverse gear pair that functions in a pure engine driving mode. Therefore, such hybrid power system also has a complex structural design.

### SUMMARY

The present disclosure has been made in view of the deficiencies of the prior art as described above. The object of the present disclosure is to provide a novel hybrid power system, which is simpler in structure, more compact in size, and less costly than the hybrid power system employing a single motor and a dedicated hybrid transmission in the prior art.

To achieve the above object, the following technical schemes are adopted.

The present disclosure provides a hybrid power system as described below. The hybrid power system comprises a transmission comprising a first input shaft, a second input shaft, an output shaft, and an intermediate shaft, the second input shaft sleeves the first input shaft and the second input shaft and the first input shaft are capable of independently rotating respectively, the output shaft is provided with a first synchronous meshing mechanism and a second synchronous meshing mechanism, the intermediate shaft is provided with a third synchronous meshing mechanism, the gearwheels corresponding to the first synchronous meshing mechanism always mesh with gearwheels fixed to the second input shaft respectively, the gearwheels corresponding to the second synchronous meshing mechanism always mesh with gearwheels fixed to the first input shaft respectively, the gearwheels corresponding to the third synchronous meshing mechanism always mesh with gearwheels fixed to the first input shaft respectively, and the intermediate shaft also has an intermediate shaft input/output gearwheel fixed thereto, the intermediate shaft input/output gearwheel always meshes with the gearwheels fixed to the second input shaft; a motor, of which an input/output shaft is in transmission connection with the second input shaft; and an engine and a double clutch, wherein the engine is capable of being in transmission connection with the first input shaft and the second output shaft via the double clutch.

Preferably, the input/output shaft of the motor is directly and coaxially connected with the second input shaft.

More preferably, the double clutch is arranged inside of a rotor of the motor.

Preferably, the motor is always in transmission connection with the second input shaft via a gear pair consisting of the gearwheels corresponding to the first synchronous meshing mechanism and the gearwheels fixed to the second input shaft; or the motor is always in transmission connection with the second input shaft via a gear pair consisting of the intermediate shaft input/output gearwheel and the gearwheels fixed to the second input shaft.

Preferably, while always meshing the gearwheels corresponding to the second synchronous meshing mechanism, the gearwheels fixed to the first input shaft also always mesh the gearwheels corresponding to the third synchronous meshing mechanism.

Preferably, one of the gearwheels fixed to the second input shaft always meshing with the gearwheels corresponding to the first synchronous meshing mechanism always meshes with the intermediate shaft input/output gearwheel.

Preferably, the hybrid power system further comprises a control module, and the hybrid power system can be controlled by the control module to implement a pure motor driving mode, a pure engine driving mode, and/or a hybrid power driving mode, wherein when the hybrid power system is in the pure motor driving mode, the engine is in a stopped state, the motor is in an operating state, a first clutch unit and a second clutch unit of the double clutch are both disengaged, and the synchronous meshing mechanisms of the transmission are engaged with the corresponding gearwheels, such that the motor individually transmits torque to the transmission for driving; when the hybrid power system is in the pure engine driving mode, the engine is in the operating state, the motor is in the stopped state, the first clutch unit or the second clutch unit of the double clutch is engaged, and the synchronous meshing mechanisms of the transmission are engaged with the corresponding gearwheels, such that the engine individually transmits torque to the transmission for driving; and/or when the hybrid power system is in the hybrid power driving mode, the engine and the motor are both in the operating state, the first clutch unit or the second clutch unit of the double clutch is engaged, and the synchronous meshing mechanisms of the transmission are engaged with the corresponding gearwheels, such that the engine and the motor transmit torque to the transmission for driving.

More preferably, when the hybrid power system is in the pure motor driving mode, the first synchronous meshing mechanism is engaged with the corresponding gearwheels, and the second synchronous meshing mechanism and the third synchronous meshing mechanism are both in the neutral state of being disengaged from the corresponding gearwheels; or the first synchronous meshing mechanism is in the neutral state of being disengaged from the corresponding gearwheels, and the second synchronous meshing mechanism and the third synchronous meshing mechanism are engaged with the corresponding gearwheels respectively.

More preferably, when the hybrid power system is in the pure engine driving mode, the first clutch unit is engaged and the second clutch unit is disengaged, the first synchronous meshing mechanism and the third synchronous meshing mechanism are engaged with the corresponding gearwheels respectively, and the second synchronous meshing mechanism is in the neutral state of being disengaged from the corresponding gearwheels; or the first clutch unit is engaged and the second clutch unit is disengaged, the first synchronous meshing mechanism is engaged with the corresponding gearwheels, and the second synchronous meshing mechanism and the third synchronous meshing mechanism are both in the neutral state of being disengaged from the corresponding gearwheels; or the first clutch unit is disengaged and the second clutch unit is engaged, the first synchronous meshing mechanism is engaged with the corresponding gearwheels, and the second synchronous meshing mechanism and the third synchronous meshing mechanism are both in the neutral state of being disengaged from the corresponding gearwheels.

More preferably, when the hybrid power system is in the hybrid power driving mode, the first clutch unit is engaged and the second clutch unit is disengaged, the first synchronous meshing mechanism is engaged with the corresponding gearwheels, the second synchronous meshing mechanism is in the neutral state of being disengaged from the corresponding gearwheels, and the third synchronous meshing mechanism is engaged with the corresponding gearwheels; or the first clutch unit is engaged and the second clutch unit is disengaged, the first synchronous meshing mechanism is engaged with the corresponding gearwheels, the second synchronous meshing mechanism is engaged with the corresponding gearwheels, and the third synchronous meshing mechanism is in the neutral state of being disengaged from the corresponding gearwheels; or the first clutch unit is disengaged and the second clutch unit is engaged, the first synchronous meshing mechanism is engaged with the corresponding gearwheels, the second synchronous meshing mechanism and the third synchronous meshing mechanism are both in the neutral state of being disengaged from the corresponding gearwheels.

More preferably, the hybrid power system can be controlled by the control module to implement an idle charge mode, wherein when the hybrid power system is in the idle charge mode, the engine and the motor are both in the operating state, the first clutch unit of the double clutch is disengaged and the second clutch unit of the double clutch is engaged, and all the synchronous meshing mechanisms of the transmission are in the neutral state of being disengaged from the corresponding gearwheels, such that the engine transmits torque to the motor to enable the motor to charge a battery.

More preferably, the hybrid power system can be controlled by the control module to implement a start-engine-while-driving mode, wherein when the hybrid power system is in the start-engine-while-driving mode, the engine and the motor are both in the operating state, the first clutch unit of the double clutch is disengaged and the second clutch unit of the double clutch is engaged, the first synchronous meshing mechanism is engaged with the corresponding gearwheels, and the second synchronous meshing mechanism and the third synchronous meshing mechanism are both in the neutral state of being disengaged from the corresponding gearwheels, such that the motor transmits torque to the transmission while transmitting torque to the engine to start it.

By the adoption of the technical schemes described above, the present disclosure provides a hybrid power system as described below. The hybrid power system comprises a motor, a double clutch, and a transmission with three synchronous meshing mechanisms. The hybrid power system can, through a reasonable structural design, implement the same as or more than the number of gears and operating modes of a hybrid power system employing a single motor and a dedicated hybrid transmission in the prior art, while being simpler in structure, more compact in size, and less costly.

### BRIEF DESCRIPTION OF THE DRAWINGS

FIG. 1 shows a schematic diagram of a connection structure of a hybrid power system according to an implementation of the present disclosure.

FIG. 2A is an illustrative diagram for illustrating the transmission path of the motor torque for driving in the transmission when the hybrid power system in FIG. 1 is in a first pure motor driving mode; FIG. 2B is an illustrative diagram for illustrating the transmission path of the motor torque for driving in the transmission when the hybrid power system in FIG. 1 is in a second pure motor driving mode; FIG. 2C is an illustrative diagram for illustrating the transmission path of the motor torque for driving in the transmission when the hybrid power system in FIG. 1 is in a third pure motor driving mode; and FIG. 2D is an illustrative diagram for illustrating the transmission path of the motor torque for driving in the transmission when the hybrid power system in FIG. 1 is in a fourth pure motor driving mode.

FIG. 3A is an illustrative diagram for illustrating the transmission path of the engine torque for driving in the transmission when the hybrid power system in FIG. 1 is in a first pure engine driving mode; FIG. 3B is an illustrative diagram for illustrating the transmission path of the engine torque for driving in the transmission when the hybrid power system in FIG. 1 is in a second pure engine driving mode; FIG. 3C is an illustrative diagram for illustrating the transmission path of the engine torque for driving in the transmission when the hybrid power system in FIG. 1 is in a third pure engine driving mode; FIG. 3D is an illustrative diagram for illustrating the transmission path of the engine torque for driving in the transmission when the hybrid power system in FIG. 1 is in a fourth pure engine driving mode; FIG. 3E is an illustrative diagram for illustrating the transmission path of the engine torque for driving in the transmission when the hybrid power system in FIG. 1 is in a fifth pure engine driving mode; FIG. 3F is an illustrative diagram for illustrating the transmission path of the engine torque for driving in the transmission when the hybrid power system in FIG. 1 is in a sixth pure engine driving mode; FIG. 3G is an illustrative diagram for illustrating the transmission path of the engine torque for driving in the transmission when the hybrid power system in FIG. 1 is in a seventh pure engine driving mode; and FIG. 3H is an illustrative diagram for illustrating the transmission path of the engine torque for driving in the transmission when the hybrid power system in FIG. 1 is in an eighth pure engine driving mode.

FIG. 4 is an illustrative diagram for illustrating the transmission path of the engine torque for driving when the hybrid power system in FIG. 1 is in an idle charge mode.

FIG. 5A is an illustrative diagram for illustrating the transmission path of the motor torque for driving when the hybrid power system in FIG. 1 is in a first start-engine-while-driving mode; and FIG. 5B is an illustrative diagram for illustrating the transmission path of the motor torque for driving when the hybrid power system in FIG. 1 is in a second start-engine-while-driving mode.

FIGS. 6A-6D are schematic diagrams of a connection structure of a variant example of the hybrid power system in FIG. 1.

### DETAILED DESCRIPTION

Implementations of the present disclosure will be described below with reference to the drawings of the specification. In the present disclosure, the “transmission connection” means that driving force/torque can be transmitted between two components and indicates that, unless indicated otherwise, driving force/torque is transmitted between these two components by using direct connection or via a gear mechanism.

(Structure of the Hybrid Power System According to an Implementation of the Present Disclosure)

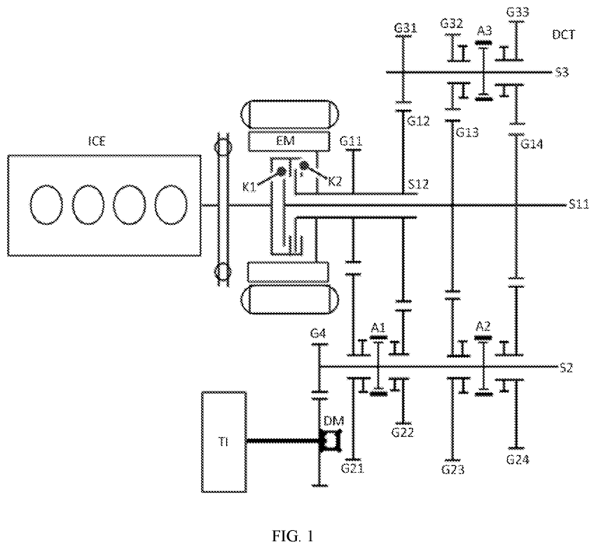

As shown in FIG. 1, the hybrid power system according to an implementation of the present disclosure comprises an engine ICE, a motor EM, a double clutch (a first clutch unit K1 and a second clutch unit K2), a transmission DCT, a differential DM, and a battery (not shown).

Specifically, in this implementation, the engine ICE is, for example, a four-cylinder engine. The engine ICE is located on the opposite side of the transmission DCT with respect to the motor EM, and an output shaft of the engine ICE is in transmission connection with a first input shaft S11 and a second input shaft S12 of the transmission DCT via the double clutch (the first clutch unit K1 and the second clutch unit K2). When the first clutch unit K1 or the second clutch unit K2 of the double clutch is engaged, the output shaft of the engine ICE is in transmission connection with the first input shaft S11 or the second input shaft S12 of the transmission DCT; when the first clutch unit K1 and the second clutch unit K2 of the double clutch are both disengaged, the transmission connections between the output shaft of the engine ICE and the first input shaft S11 and the second input shaft S12 of the transmission DCT are both disconnected.

In this implementation, the input/output shaft of the motor EM is directly and coaxially connected with the second input shaft S12 of the transmission DCT, such that the driving force/torque can be bidirectionally transmitted between the motor EM and the transmission DCT. The “directly and coaxially connected” described above means that the input/output shaft of the motor EM and the second input shaft S12 of the transmission DCT may be the same shaft, or that the input/output shaft of the motor EM and the second input shaft S12 of the transmission DCT are rigidly and coaxially connected therebetween. The motor EM works as a motor when powered by a battery (not shown) and transmits driving force/torque to the second input shaft S12 of the transmission DCT; the motor EM works as an electric generator and charges the battery when obtaining the driving force/torque from the second input shaft S12.

In this implementation, the double clutch (the first clutch unit K1 and the second clutch unit K2) is, for example, a conventional friction double clutch, and the structure of the double clutch is not specified herein. In addition, in this implementation, the double clutch may be integrated inside of the rotor of the motor EM, such that the axial dimension of the entire hybrid power system can be reduced.

In this implementation, the battery (not shown) is electrically connected to the motor EM, such that the battery can supply electrical energy to the motor EM and the battery can be charged via the motor EM.

Further, in this implementation, as shown in FIG. 1, the transmission DCT comprises a first input shaft S11, a second input shaft S12, an output shaft S2 and an intermediate shaft S3. The first input shaft S11 is a solid shaft, the second input shaft S12 is a hollow shaft, and the first input shaft S11 penetrates through the interior of the second input shaft S12, that is, the second input shaft S12 sleeves the first input shaft S11, and the central axis of the first input shaft S11 coincides with that of the second input shaft S12. The first input shaft S11 and the second input shaft S12 can rotate independently of each other. The output shaft S2 is disposed in parallel with and spaced from the first input shaft S11 and the second input shaft S12, and the intermediate shaft S3 is disposed in parallel with and spaced from the first input shaft S11 and the second input shaft S12.

In addition, the transmission DCT further comprises a plurality of gearwheels (gearwheels G11-G33), synchronous meshing mechanisms A1-A3 and an output gearwheel (gearwheel G4) of the transmission DCT arranged on various shafts. The first synchronous meshing mechanism A1 and the second synchronous meshing mechanism A2 are both arranged on the output shaft S2, and the third synchronous meshing mechanism A3 is arranged on the intermediate shaft S3. Each of the synchronous meshing mechanisms A1, A2 and A3 comprises a synchronizer and a gear actuator and corresponds to two gearwheels respectively, wherein the first synchronous meshing mechanism A1 corresponds to the gearwheels G21 and G22, the second synchronous meshing mechanism A2 corresponds to the gearwheels G23 and G24, and the third synchronous meshing mechanism A3 corresponds to the gearwheels G32 and G33.

Hereinafter, the gear pairs constituted by and between the gearwheels on the shafts of the transmission DCT will be described.

The gearwheel G11 is fixed to the second input shaft S12, the gearwheel G21 is arranged on the output shaft S2, and the gearwheel G11 always meshes with the gearwheel G21 to constitute a first gear pair.

The gearwheel G12 and the gearwheel G11 are fixed to the second input shaft S12 spaced apart from each other, the gearwheel G22 and the gearwheel G21 are arranged on the output shaft S2 spaced apart from each other, and the gearwheel G12 always meshes with the gearwheel G22 to constitute a second gear pair.

The gearwheel G31 (as the intermediate shaft input/output gearwheel of the intermediate shaft S3) is fixed to the intermediate shaft S3, and the gearwheel G12 also always meshes with the gearwheel G31 to constitute a third gear pair.

The gearwheel G13 is fixed to the first input shaft S11, the gearwheel G23 and the gearwheel G22 are arranged on the output shaft S2 spaced apart from each other, and the gearwheel G13 always meshes with the gearwheel G23 to constitute a fourth gear pair.

The gearwheel G32 and the gearwheel G31 are arranged on the intermediate shaft S3 spaced apart from each other, and the gearwheel G13 also always meshes with the gearwheel G32 to constitute a fifth gear pair.

The gearwheel G14 and the gearwheel G13 are fixed to the first input shaft S11 spaced apart from each other, the gearwheel G24 and the gearwheel G23 are arranged on the output shaft S2 spaced apart from each other, and the gearwheel G14 always meshes with the gearwheel G24 to constitute a sixth gear pair.

The gearwheel G33 and the gearwheel G32 are arranged on the intermediate shaft S3 spaced apart from each other, and the gearwheel G14 also always meshes with the gearwheel G33 to constitute a seventh gear pair.

In this way, by adopting the structure described above, the plurality of gearwheels G11-G33 of the transmission DCT mesh with one another to constitute seven gear pairs corresponding to a plurality of gears of the transmission DCT respectively, and the synchronous meshing mechanisms A1-A3 can be engaged with or disengaged from the corresponding gearwheels to achieve a gear shift. When gear shift by the transmission DCT is needed, the synchronizers of the corresponding synchronous meshing mechanisms A1-A3 act to be engaged with the corresponding gearwheels to achieve selective transmission connection or disconnection among the shafts.

In this implementation, the differential input gear of the differential DM always meshes with the gearwheel G4 of the transmission DCT fixed to the output shaft S2, such that the differential DM is always in transmission connection with the output shaft S2 of the transmission DCT. In this implementation, the differential DM is not included in the transmission DCT, but can be integrated into the transmission DCT as needed.

In this way, the driving force/torque from the engine ICE and the motor EM can be transmitted to the differential DM via the transmission DCT so as to be further output to the wheels TI of a vehicle.

The specific structure of the hybrid power system according to an implementation of the present disclosure is described in detail above, and the operating modes and the torque transmission paths of the hybrid power system will be described below.

(Operating Modes and Torque Transmission Paths of the Hybrid Power System According to an Implementation of the Present Disclosure)

The hybrid power system according to an implementation of the present disclosure illustrated in FIG. 1 has eight operating modes, namely a pure motor driving mode, a pure engine driving mode, a hybrid power driving mode, an idle charge mode, a start-engine-while-driving mode (an operating mode in which the engine is started while the vehicle is purely driven by the motor), a braking energy recovery mode, a load point shifting mode, and a torque-compensation-during-gearshift mode.

The operating states of the motor EM, the engine ICE, the first clutch unit K1, the second clutch unit K2, the first synchronous meshing mechanism A1, the second synchronous meshing mechanism A2 and the third synchronous meshing mechanism A3 in the first five of the above-mentioned eight operating modes are shown in Table 1 below.

The following explanation is provided for the contents in Table 1 above.

1. About the modes in Table 1

EM1 to EM4 represent four pure motor driving modes, among which EM1 can also be used in the case of reverse gear.

ICE1 to ICE8 represent eight pure engine driving modes.

Hybrid1 to Hybrid10 represent ten hybrid power driving modes, where Hybrid1 is equivalent to EM1+ICE1, Hybrid2 is equivalent to EM1+ICE2, Hybrid3 is equivalent to EM1+ICE3, Hybrid4 is equivalent to EM1+ICE4, Hybrid5 is equivalent to EM1+ICE5, Hybrid6 is equivalent to EM2+ICE4, Hybrid1 is equivalent to EM2+ICE5, Hybrid8 is equivalent to EM2+ICE6, Hybrid9 is equivalent to EM2+ICE7, and Hybrid10 is equivalent to EM2+ICE8.

SC represents the idle charge mode.

ICE start1 and ICE start2 represent two start-engine-while-driving modes.

2. EM, ICE, K1, K2, A1, A2, and A3 in the first row of Table 1 respectively correspond to the reference numerals in FIG. 1, i.e., they represent the motor, the engine, the first clutch unit, the second clutch unit, the first synchronous meshing mechanism, the second synchronous meshing mechanism, and the third synchronous meshing mechanism, respectively, of the hybrid power system in FIG. 1.

3. About the symbol “ [symbol] ”

For the columns of Table 1 where EM and ICE are located, the presence of this symbol indicates that the motor EM and the engine ICE are in an operating state, and the absence of this symbol indicates that the motor EM and the engine ICE are in a stopped state.

For the columns of Table 1 where K1 and K2 are located, the presence of this symbol indicates that the first clutch unit K1 and the second clutch unit K2 are engaged, and the absence of this symbol indicates that the first clutch unit K1 and the second clutch unit K2 are disengaged.

For the columns of Table 1 where A1, A2 and A3 are located, the presence of this symbol indicates that the first synchronous meshing mechanism A1, the second synchronous meshing mechanism A2 and the third synchronous meshing mechanism A3 are in the corresponding states of “L”, “N” and “R”.

4. About the symbols “L”, “N” and “R” corresponding to A1, A2 and A3

“L” indicates the state of being engaged with the gearwheel G21 for the first synchronous meshing mechanism A1, the state of being engaged with the gearwheel G23 for the second synchronous meshing mechanism A2, and the state of being engaged with the gearwheel G32 for the third synchronous meshing mechanism A3.

“N” indicates the neutral state of being disengaged from both gearwheel G21 and gearwheel G22 for the first synchronous meshing mechanism A1, the neutral state of being disengaged from both gearwheel G23 and gearwheel G24 for the second synchronous meshing mechanism A2, and the neutral state of being disengaged from both gearwheel G32 and gearwheel G33 for the third synchronous meshing mechanism A3.

“R” indicates the state of being engaged with the gearwheel G22 for the first synchronous meshing mechanism A1, the state of being engaged with the gearwheel G24 for the second synchronous meshing mechanism A2, and the state of being engaged with the gearwheel G33 for the third synchronous meshing mechanism A3.

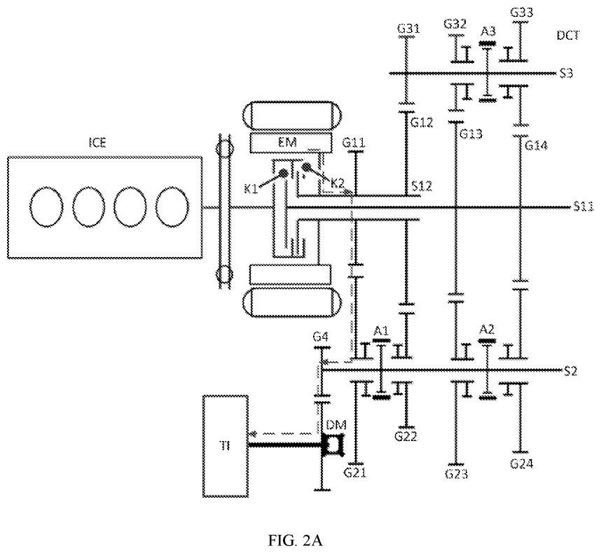

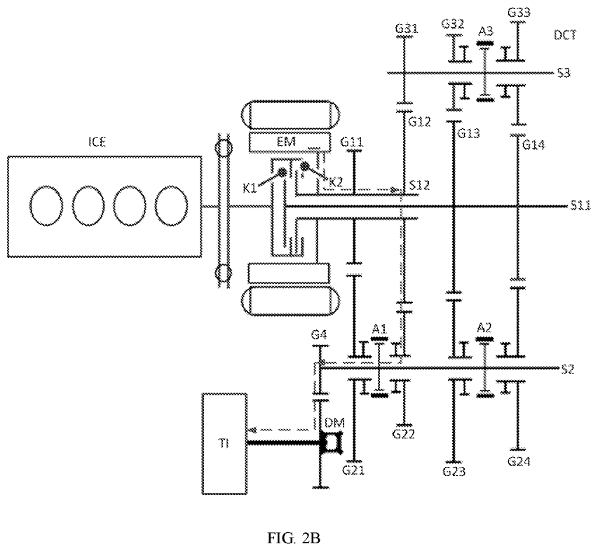

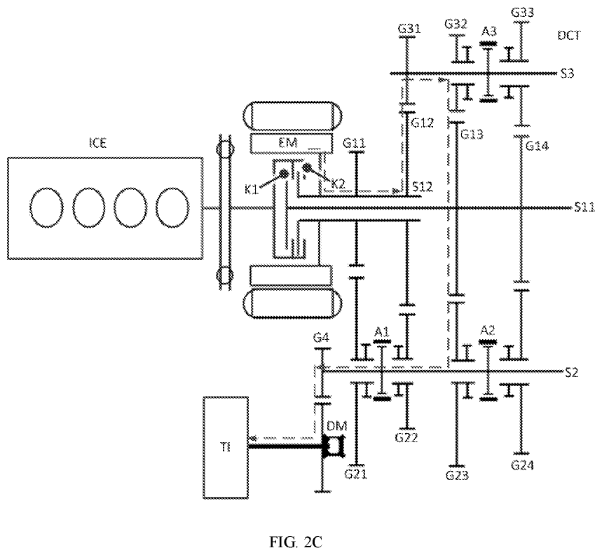

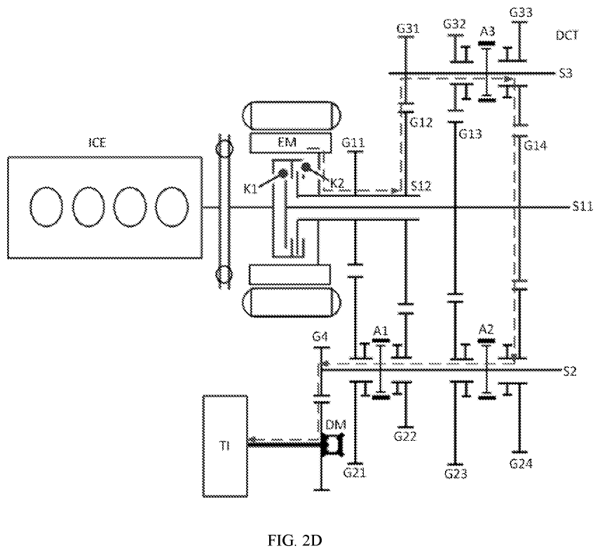

In conjunction with Table 1 and FIGS. 2A-5B above, the operating modes of the hybrid power system in FIG. 1 are described in more details.

As shown in Table 1 above, the hybrid power system can be controlled by the control module (not shown) of the hybrid power system to implement four pure motor driving modes EM1 to EM4.

When the hybrid power system is in the first pure motor driving mode EM1,

the motor EM is in the operating state;

the engine ICE is in the stopped state;

the first clutch unit K1 and the second clutch unit K2 are both disengaged;

in the transmission DCT, the first synchronous meshing mechanism A1 is engaged with the gearwheel G21, and the second synchronous meshing mechanism A2 and the third synchronous meshing mechanism A3 are both in the neutral state.

Thus, as shown in FIG. 2A, the motor EM transmits torque to the differential DM for driving via the second input shaft S12→gearwheel G11→gearwheel G21→output shaft S2→gearwheel G4.

When the hybrid power system is in the second pure motor driving mode EM2,

the motor EM is in the operating state;

the engine ICE is in the stopped state;

the first clutch unit K1 and the second clutch unit K2 are both disengaged;

in the transmission DCT, the first synchronous meshing mechanism A1 is engaged with the gearwheel G22, and the second synchronous meshing mechanism A2 and the third synchronous meshing mechanism A3 are both in the neutral state.

Thus, as shown in FIG. 2B, the motor EM transmits torque to the differential DM for driving via the second input shaft S12→gearwheel G12→gearwheel G22→output shaft S2→gearwheel G4.

When the hybrid power system is in the third pure motor driving mode EM3,

the motor EM is in the operating state;

the engine ICE is in the stopped state;

the first clutch unit K1 and the second clutch unit K2 are both disengaged;

in the transmission DCT, the first synchronous meshing mechanism A1 is in the neutral state, the second synchronous meshing mechanism A2 is engaged with the gearwheel G23, and the third synchronous meshing mechanism A3 is engaged with the gearwheel G32.

Thus, as shown in FIG. 2C, the motor EM transmits torque to the differential DM for driving via the second input shaft S12→gearwheel G12→gearwheel G31→intermediate shaft S3→gearwheel G32→gearwheel G13→gearwheel G23→output shaft S2→gearwheel G4.

When the hybrid power system is in the fourth pure motor driving mode EM4,

the motor EM is in the operating state;

the engine ICE is in the stopped state;

the first clutch unit K1 and the second clutch unit K2 are both disengaged;

in the transmission DCT, the first synchronous meshing mechanism A1 is in the neutral state, the second synchronous meshing mechanism A2 is engaged with the gearwheel G24, and the third synchronous meshing mechanism A3 is engaged with the gearwheel G33.

Thus, as shown in FIG. 2D, the motor EM transmits torque to the differential DM for driving via the second input shaft S12→gearwheel G12→gearwheel G31→intermediate shaft S3→gearwheel G33→gearwheel G14→gearwheel G24→output shaft S2→gearwheel G4.

Further, as shown in Table 1, the hybrid power system can be controlled by the control module of the hybrid power system to implement eight pure engine driving modes ICE1 to ICE8.

When the hybrid power system is in the first pure engine driving mode ICE1,

the motor EM is in the stopped state;

the engine ICE is in the operating state;

the first clutch unit K1 is engaged, and the second clutch unit K2 is disengaged;

in the transmission DCT, the first synchronous meshing mechanism A1 is engaged with the gearwheel G21, the second synchronous meshing mechanism A2 is in the neutral state, and the third synchronous meshing mechanism A3 is engaged with the gearwheel G33.

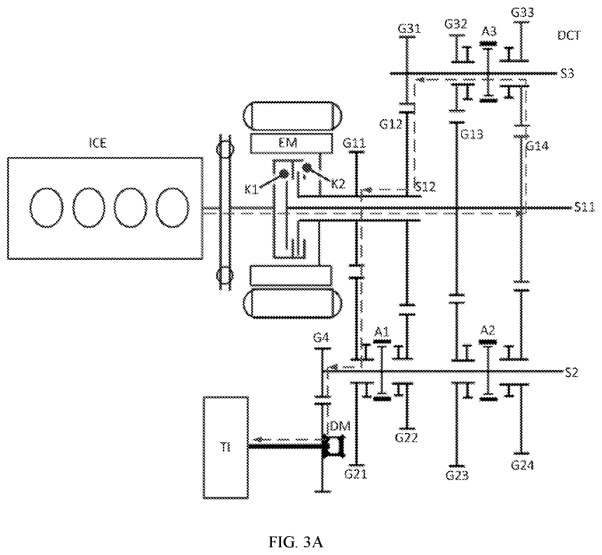

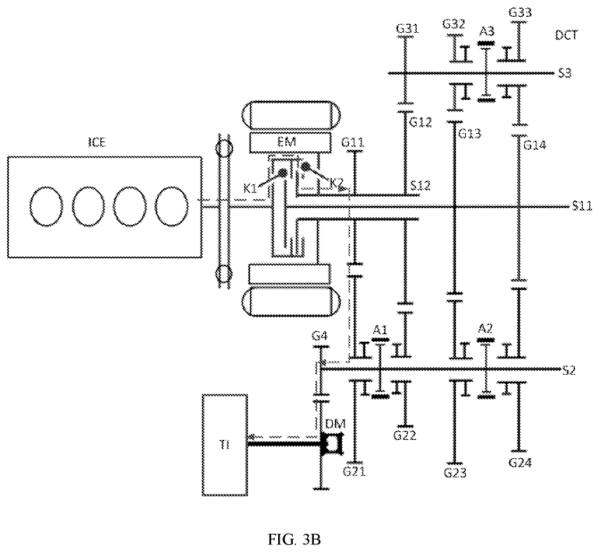

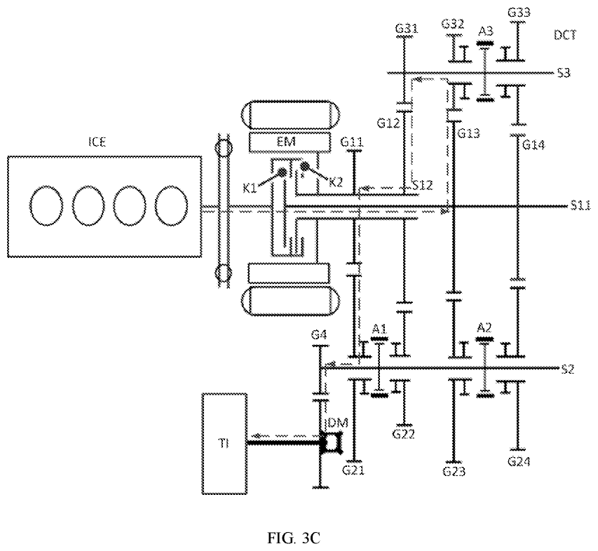

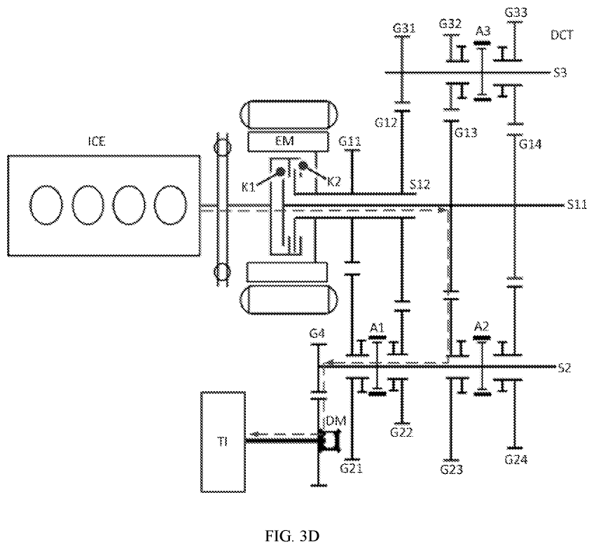

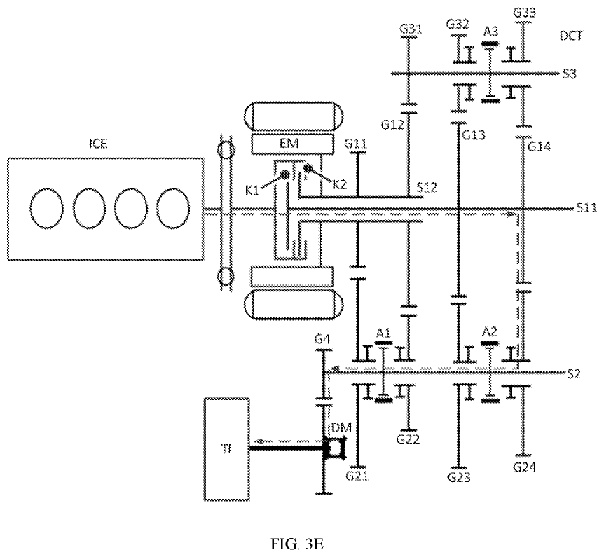

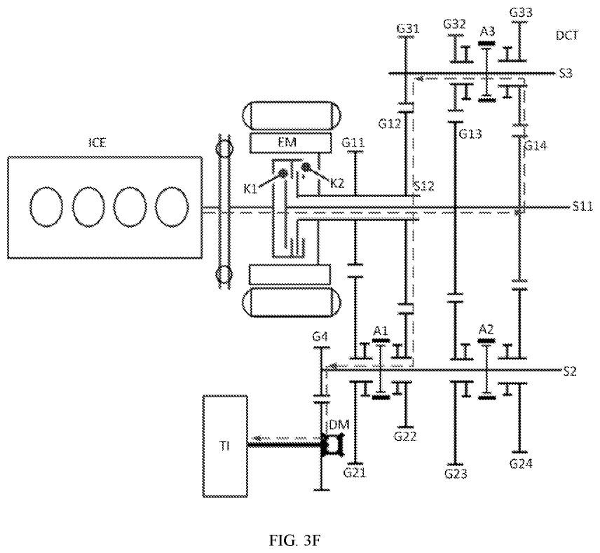

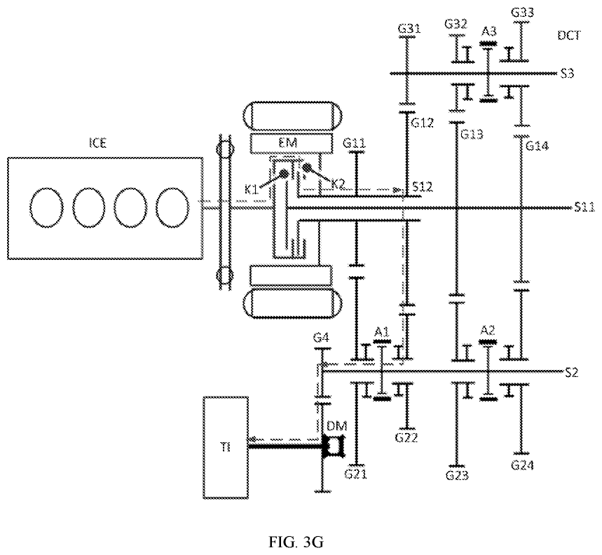

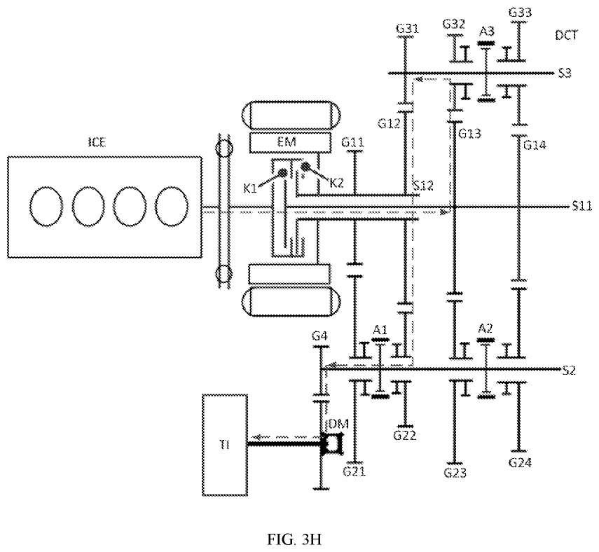

Thus, as shown in FIG. 3A, the engine ICE transmits torque to the differential DM for driving via the first input shaft S11→gearwheel G14→gearwheel G33→intermediate shaft S3→gearwheel G31→gearwheel G12→second input shaft S12→gearwheel G11→gearwheel G21→output shaft S2→gearwheel G4.

When the hybrid power system is in the second pure engine driving mode ICE2,

the motor EM is in the stopped state;

the engine ICE is in the operating state;

the first clutch unit K1 is disengaged, and the second clutch unit K2 is engaged;

in the transmission DCT, the first synchronous meshing mechanism A1 is engaged with the gearwheel G21, and the second synchronous meshing mechanism A2 and the third synchronous meshing mechanism A3 are both in the neutral state.

Thus, as shown in FIG. 3B, the engine ICE transmits torque to the differential DM for driving via the second input shaft S12→gearwheel G11→gearwheel G21→output shaft S2→gearwheel G4.

When the hybrid power system is in the third pure engine driving mode ICE3,

the motor EM is in the stopped state;

the engine ICE is in the operating state;

the first clutch unit K1 is engaged, and the second clutch unit K2 is disengaged;

in the transmission DCT, the first synchronous meshing mechanism A1 is engaged with the gearwheel G21, the second synchronous meshing mechanism A2 is in the neutral state, and the third synchronous meshing mechanism A3 is engaged with the gearwheel G32.

Thus, as shown in FIG. 3C, the engine ICE transmits torque to the differential DM for driving via the first input shaft S11→gearwheel G13→gearwheel G32→intermediate shaft S3→gearwheel G31→gearwheel G12→second input shaft S12→gearwheel G11→gearwheel G21→output shaft S2→gearwheel G4.

When the hybrid power system is in the fourth pure engine driving mode ICE4,

the motor EM is in the stopped state;

the engine ICE is in the operating state;

the first clutch unit K1 is engaged, and the second clutch unit K2 is disengaged;

in the transmission DCT, the first synchronous meshing mechanism A1 and the third synchronous meshing mechanism A3 are both in the neutral state, and the second synchronous meshing mechanism A2 is engaged with the gearwheel G23.

Thus, as shown in FIG. 3D, the engine ICE transmits torque to the differential DM for driving via the first input shaft S11→gearwheel G13→gearwheel G23→output shaft S2→gearwheel G4.

When the hybrid power system is in the fifth pure engine driving mode ICE5,

the motor EM is in the stopped state;

the engine ICE is in the operating state;

the first clutch unit K1 is engaged, and the second clutch unit K2 is disengaged;

in the transmission DCT, the first synchronous meshing mechanism A1 and the third synchronous meshing mechanism A3 are both in the neutral state, and the second synchronous meshing mechanism A2 is engaged with the gearwheel G24.

Thus, as shown in FIG. 3E, the engine ICE transmits torque to the differential DM for driving via the first input shaft S11→gearwheel G14→gearwheel G24→output shaft S2→gearwheel G4.

When the hybrid power system is in the sixth pure engine driving mode ICE6,

the motor EM is in the stopped state;

the engine ICE is in the operating state;

the first clutch unit K1 is engaged, and the second clutch unit K2 is disengaged;

in the transmission DCT, the first synchronous meshing mechanism A1 is engaged with the gearwheel G22, the second synchronous meshing mechanism A2 is in the neutral state, and the third synchronous meshing mechanism A3 is engaged with the gearwheel G33.

Thus, as shown in FIG. 3F, the engine ICE transmits torque to the differential DM for driving via the first input shaft S11→gearwheel G14→gearwheel G33→intermediate shaft S3→gearwheel G31→gearwheel G12→gearwheel G22→output shaft S2→gearwheel G4.

When the hybrid power system is in the seventh pure engine driving mode ICE7,

the motor EM is in the stopped state;

the engine ICE is in the operating state;

the first clutch unit K1 is disengaged, and the second clutch unit K2 is engaged;

in the transmission DCT, the first synchronous meshing mechanism A1 is engaged with the gearwheel G22, and the second synchronous meshing mechanism A2 and the third synchronous meshing mechanism A3 are both in the neutral state.

Thus, as shown in FIG. 3G, the engine ICE transmits torque to the differential DM for driving via the second input shaft S12→gearwheel G12→gearwheel G22→output shaft S2→gearwheel G4.

When the hybrid power system is in the eighth pure engine driving mode ICE8,

the motor EM is in the stopped state;

the engine ICE is in the operating state;

the first clutch unit K1 is engaged, and the second clutch unit K2 is disengaged;

in the transmission DCT, the first synchronous meshing mechanism A1 is engaged with the gearwheel G22, the second synchronous meshing mechanism A2 is in the neutral state, and the third synchronous meshing mechanism A3 is engaged with the gearwheel G32.

Thus, as shown in FIG. 3H, the engine ICE transmits torque to the differential DM for driving via the first input shaft S11→gearwheel G13→gearwheel G32→intermediate shaft S3→gearwheel G31→gearwheel G12→gearwheel G22→output shaft S2→gearwheel G4.

Further, as shown in Table 1, the hybrid power system can be controlled by the control module of the hybrid power system to implement ten hybrid power driving modes Hybrid1 to Hybrid10.

When the hybrid power system is in the first hybrid power driving mode Hybrid1,

the motor EM and the engine ICE are both in the operating state;

the first clutch unit K1 is engaged, and the second clutch unit K2 is disengaged;

in the transmission DCT, the first synchronous meshing mechanism A1 is engaged with the gearwheel G21, the second synchronous meshing mechanism A2 is in the neutral state, and the third synchronous meshing mechanism A3 is engaged with the gearwheel G33.

Thus, as shown in FIG. 2A and FIG. 3A, the motor EM transmits torque to the differential DM for driving via the second input shaft S12→gearwheel G11→gearwheel G21→output shaft S2→gearwheel G4, and the engine ICE transmits torque to the differential DM for driving via the first input shaft S11→gearwheel G14→gearwheel G33→intermediate shaft S3→gearwheel G31→gearwheel G12→second input shaft S12→gearwheel G11→gearwheel G21→output shaft S2→gearwheel G4.

When the hybrid power system is in the second hybrid power driving mode Hybrid2,

the motor EM and the engine ICE are both in the operating state;

the first clutch unit K1 is disengaged, and the second clutch unit K2 is engaged;

in the transmission DCT, the first synchronous meshing mechanism A1 is engaged with the gearwheel G21, and the second synchronous meshing mechanism A2 and the third synchronous meshing mechanism A3 are both in the neutral state.

Thus, as shown in FIG. 2A and FIG. 3B, the motor EM transmits torque to the differential DM for driving via the second input shaft S12→gearwheel G11→gearwheel G21→output shaft S2→gearwheel G4, and the engine ICE transmits torque to the differential DM for driving via the second input shaft S12→gearwheel G11→gearwheel G21→output shaft S2→gearwheel G4.

When the hybrid power system is in the third hybrid power driving mode Hybrid3,

the motor EM and the engine ICE are both in the operating state;

the first clutch unit K1 is engaged, and the second clutch unit K2 is disengaged;

in the transmission DCT, the first synchronous meshing mechanism A1 is engaged with the gearwheel G21, the second synchronous meshing mechanism A2 is in the neutral state, and the third synchronous meshing mechanism A3 is engaged with the gearwheel G32.

Thus, as shown in FIG. 2A and FIG. 3C, the motor EM transmits torque to the differential DM for driving via the second input shaft S12→gearwheel G11→gearwheel G21→output shaft S2→gearwheel G4, and the engine ICE transmits torque to the differential DM for driving via the first input shaft S11→gearwheel G13→gearwheel G32→intermediate shaft S3→gearwheel G31→gearwheel G12→second input shaft S12→gearwheel G11→gearwheel G21→output shaft S2→gearwheel G4.

When the hybrid power system is in the fourth hybrid power driving mode Hybrid4,

the motor EM and the engine ICE are both in the operating state;

the first clutch unit K1 is engaged, and the second clutch unit K2 is disengaged;

in the transmission DCT, the first synchronous meshing mechanism A1 is engaged with the gearwheel G21, the second synchronous meshing mechanism A2 is engaged with the gearwheel G23, and the third synchronous meshing mechanism A3 is in the neutral state.

Thus, as shown in FIG. 2A and FIG. 3D, the motor EM transmits torque to the differential DM for driving via the second input shaft S12→gearwheel G11→gearwheel G21→output shaft S2→gearwheel G4, and the engine ICE transmits torque to the differential DM for driving via the first input shaft S11→gearwheel G13→gearwheel G23→output shaft S2→gearwheel G4.

When the hybrid power system is in the fifth hybrid power driving mode Hybrid5,

the motor EM and the engine ICE are both in the operating state;

the first clutch unit K1 is engaged, and the second clutch unit K2 is disengaged;

in the transmission DCT, the first synchronous meshing mechanism A1 is engaged with the gearwheel G21, the second synchronous meshing mechanism A2 is engaged with the gearwheel G24, and the third synchronous meshing mechanism A3 is in the neutral state.

Thus, as shown in FIG. 2A and FIG. 3E, the motor EM transmits torque to the differential DM for driving via the second input shaft S12→gearwheel G11→gearwheel G21→output shaft S2→gearwheel G4, and the engine ICE transmits torque to the differential DM for driving via the first input shaft S11→gearwheel G14→gearwheel G24→output shaft S2→gearwheel G4.

When the hybrid power system is in the sixth hybrid power driving mode Hybrid6,

the motor EM and the engine ICE are both in the operating state;

the first clutch unit K1 is engaged, and the second clutch unit K2 is disengaged;

in the transmission DCT, the first synchronous meshing mechanism A1 is engaged with the gearwheel G22, the second synchronous meshing mechanism A2 is engaged with the gearwheel G23, and the third synchronous meshing mechanism A3 is in the neutral state.

Thus, as shown in FIG. 2B and FIG. 3D, the motor EM transmits torque to the differential DM for driving via the second input shaft S12→gearwheel G12→gearwheel G22→output shaft S2→gearwheel G4, and the engine ICE transmits torque to the differential DM for driving via the first input shaft S11→gearwheel G13→gearwheel G23→output shaft S2→gearwheel G4.

When the hybrid power system is in the seventh hybrid power driving mode Hybrid7,

the motor EM and the engine ICE are both in the operating state;

the first clutch unit K1 is engaged, and the second clutch unit K2 is disengaged;

in the transmission DCT, the first synchronous meshing mechanism A1 is engaged with the gearwheel G22, and the second synchronous meshing mechanism A2 and the third synchronous meshing mechanism A3 are both in the neutral state.

Thus, as shown in FIG. 2B and FIG. 3E, the motor EM transmits torque to the differential DM for driving via the second input shaft S12→gearwheel G12→gearwheel G22→output shaft S2→gearwheel G4, and the engine ICE transmits torque to the differential DM for driving via the first input shaft S11→gearwheel G14→gearwheel G24→output shaft S2→gearwheel G4.

When the hybrid power system is in the eighth hybrid power driving mode Hybrid8,

the motor EM and the engine ICE are both in the operating state;

the first clutch unit K1 is engaged, and the second clutch unit K2 is disengaged;

in the transmission DCT, the first synchronous meshing mechanism A1 is engaged with the gearwheel G22, the second synchronous meshing mechanism A2 is in the neutral state, and the third synchronous meshing mechanism A3 is engaged with the gearwheel G33.

Thus, as shown in FIG. 2B and FIG. 3F, the motor EM transmits torque to the differential DM for driving via the second input shaft S12→gearwheel G12→gearwheel G22→output shaft S2→gearwheel G4, and the engine ICE transmits torque to the differential DM for driving via the first input shaft S11→gearwheel G14→gearwheel G33→intermediate shaft S3→gearwheel G31→gearwheel G12→gearwheel G22→output shaft S2→gearwheel G4.

When the hybrid power system is in the ninth hybrid power driving mode Hybrid9,

the motor EM and the engine ICE are both in the operating state;

the first clutch unit K1 is disengaged, and the second clutch unit K2 is engaged;

in the transmission DCT, the first synchronous meshing mechanism A1 is engaged with the gearwheel G22, and the second synchronous meshing mechanism A2 and the third synchronous meshing mechanism A3 are both in the neutral state.

Thus, as shown in FIG. 2B and FIG. 3G, the motor EM transmits torque to the differential DM for driving via the second input shaft S12→gearwheel G12→gearwheel G22→output shaft S2→gearwheel G4, and the engine ICE transmits torque to the differential DM for driving via the second input shaft S12→gearwheel G12→gearwheel G22→output shaft S2→gearwheel G4.

When the hybrid power system is in the tenth hybrid power driving mode Hybrid10,

the motor EM and the engine ICE are both in the operating state;

the first clutch unit K1 is engaged, and the second clutch unit K2 is disengaged;

in the transmission DCT, the first synchronous meshing mechanism A1 is engaged with the gearwheel G22, the second synchronous meshing mechanism A2 is in the neutral state, and the third synchronous meshing mechanism A3 is engaged with the gearwheel G32.

Thus, as shown in FIG. 2B and FIG. 3H, the motor EM transmits torque to the differential DM for driving via the second input shaft S12→gearwheel G12→gearwheel G22→output shaft S2→gearwheel G4, and the engine ICE transmits torque to the differential DM for driving via the first input shaft S11→gearwheel G13→gearwheel G32→intermediate shaft S3→gearwheel G31→gearwheel G12→gearwheel G22→output shaft S2→gearwheel G4.

Further, as shown in Table 1, the hybrid power system can be controlled by the control module of the hybrid power system to implement the idle charge mode SC.

When the hybrid power system is in the idle charge mode SC,

the motor EM and the engine ICE are both in the operating state;

the first clutch unit K1 is disengaged, and the second clutch unit K2 is engaged;

in the transmission DCT, the first synchronous meshing mechanism A1, the second synchronous meshing mechanism A2 and the third synchronous meshing mechanism A3 are all in the neutral state.

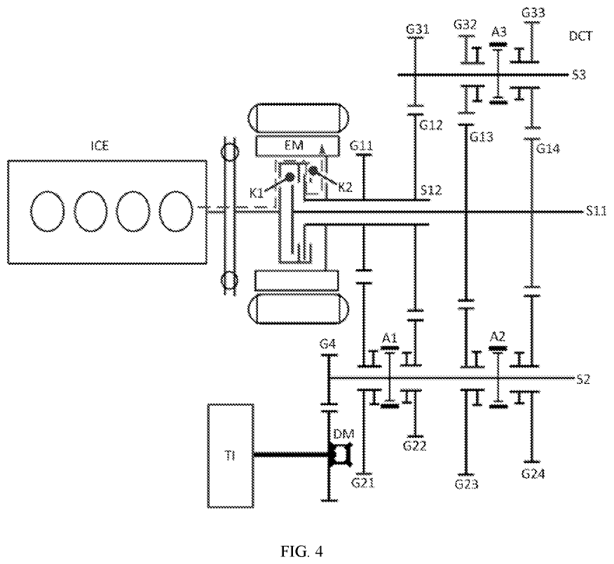

Thus, as shown in FIG. 4, the engine ICE transmits torque to the motor EM via the second input shaft S12 to enable the motor EM to charge the battery.

Further, as shown in Table 1, the hybrid power system can be controlled by the control module of the hybrid power system to implement two start-engine-while-driving modes ICE start1 and ICE start2.

When the hybrid power system is in the first start-engine-while-driving mode ICE start1,

the motor EM and the engine ICE are both in the operating state;

the first clutch unit K1 is disengaged, and the second clutch unit K2 is engaged;

in the transmission DCT, the first synchronous meshing mechanism A1 is engaged with the gearwheel G21, and the second synchronous meshing mechanism A2 and the third synchronous meshing mechanism A3 are both in the neutral state.

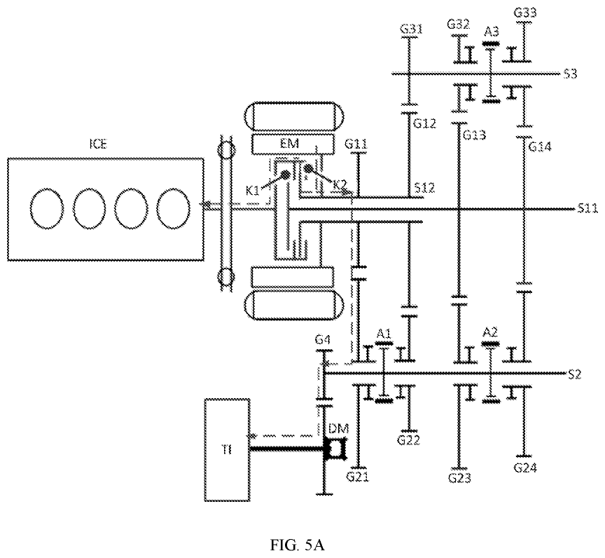

Thus, as shown in FIG. 5A, the motor EM transmits torque to the differential DM for driving via the second input shaft S12→gearwheel G11→gearwheel G21→output shaft S2→gearwheel G4, and the motor EM transmits torque to the engine ICE for starting the engine ICE via the second input shaft S12.

When the hybrid power system is in the second start-engine-while-driving mode ICE start2,

the motor EM and the engine ICE are both in the operating state;

the first clutch unit K1 is disengaged, and the second clutch unit K2 is engaged;

in the transmission DCT, the first synchronous meshing mechanism A1 is engaged with the gearwheel G22, and the second synchronous meshing mechanism A2 and the third synchronous meshing mechanism A3 are both in the neutral state.

Thus, as shown in FIG. 5B, the motor EM transmits torque to the differential DM for driving via the second input shaft S12→gearwheel G12→gearwheel G22→output shaft S2→gearwheel G4, and the motor EM transmits torque to the engine ICE for starting the engine ICE via the second input shaft S12.

Although Table 1 does not show the states of the components of the hybrid power system in FIG. 1 in the braking energy recovery mode, the load point shifting mode, and the torque-compensation-during-gearshift mode, it can be understood that the synchronous meshing mechanisms A1-A3 of the transmission DCT can perform appropriate actions in these three modes to achieve the corresponding functions.

For example, when the hybrid power system is in the braking energy recovery mode, it is possible to make both the first clutch unit K1 and the second clutch unit K2 disengaged, the first synchronous meshing mechanism A1 engaged with the gearwheel G21, and the second synchronous meshing mechanism A2 and the third synchronous meshing mechanism A3 both in the neutral state. Thus, a portion of the braking energy is transmitted to the motor EM via the differential DM→gearwheel G4→output shaft S2→gearwheel G21→gearwheel G11→second input shaft S12, such that the motor EM can charge the battery, thereby recovering a portion of the braking energy.

(Structure of the Hybrid Power System According to a Variant Example of the Present Disclosure)

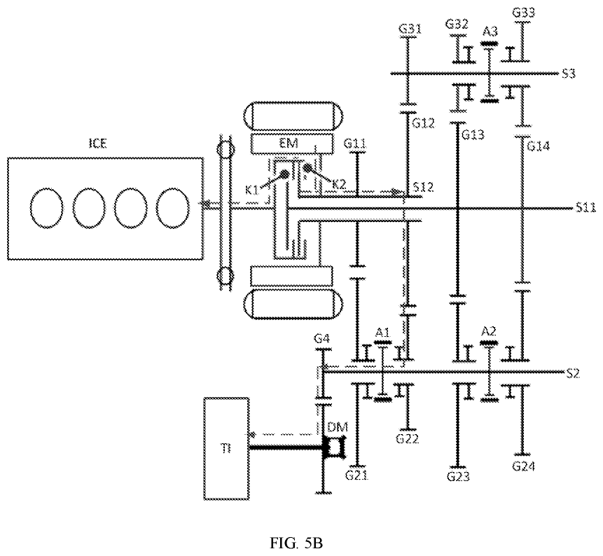

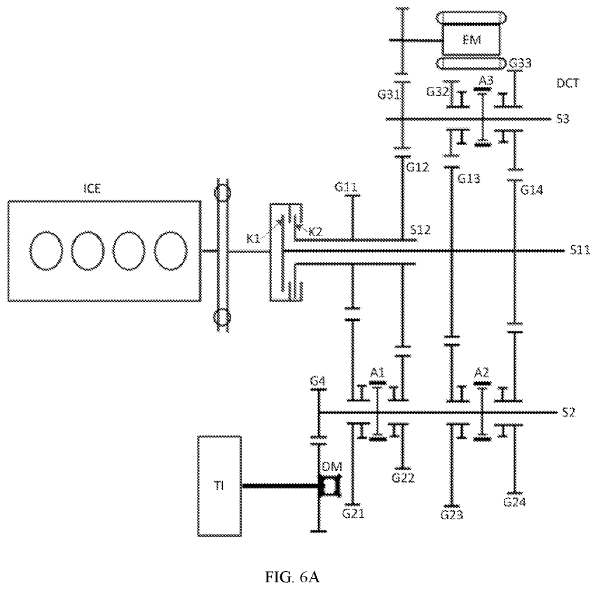

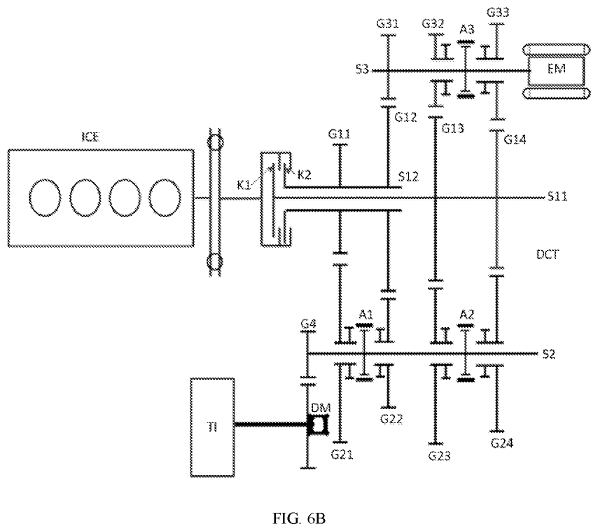

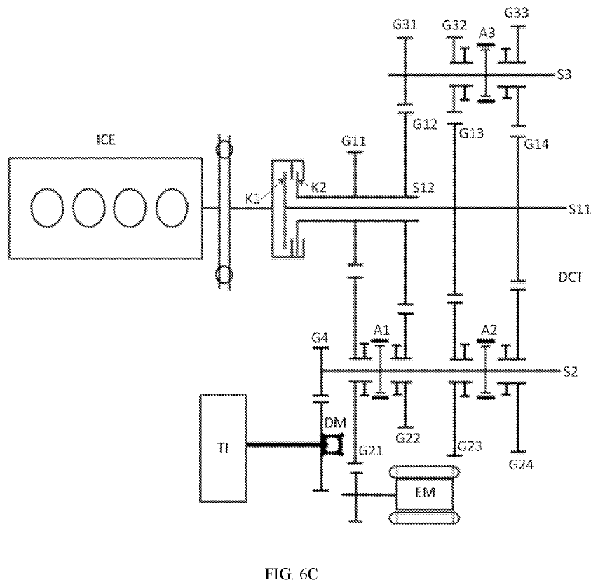

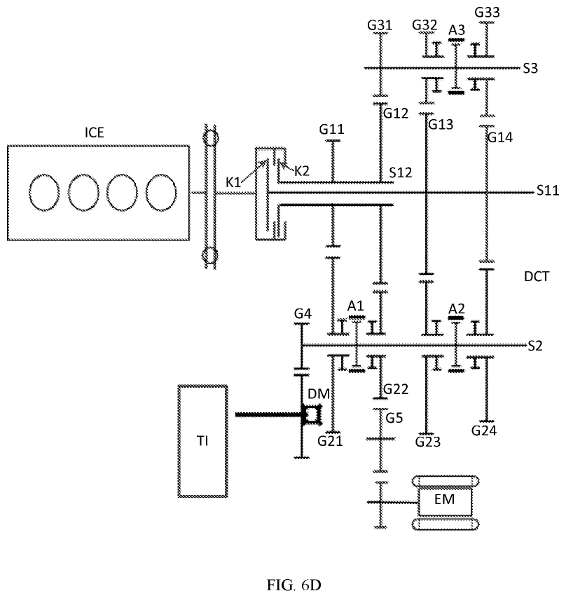

The structure of the hybrid power system according to a variant example of the present disclosure illustrated in FIGS. 6A-6D differs from the structure of the hybrid power system according to an embodiment of the present disclosure illustrated in FIG. 1 only in the way of the transmission connection between the motor EM and the second input shaft S12.

As shown in FIG. 6A, the gearwheel of the input/output shaft of the motor EM always meshes with the gearwheel G31 fixed to the intermediate shaft S3, and the gearwheel G31 always meshes with the gearwheel G12 fixed to the second input shaft S12, so the input/output shaft of the motor EM is always in transmission connection with the second input shaft S12.

As shown in FIG. 6B, the input/output shaft of the motor EM is directly and coaxially connected with the intermediate shaft S3, so the input/output shaft of the motor EM is always in transmission connection with the second input shaft S12 via the gearwheel G31 fixed to the intermediate shaft S3 and the gearwheel G12 fixed to the second input shaft S12.

As shown in FIG. 6C, the gearwheel of the input/output shaft of the motor EM always meshes with the gearwheel G21 arranged on the output shaft S2, and the gearwheel G21 always meshes with the gearwheel G11 fixed to the second input shaft S12, so the input/output shaft of the motor EM is always in transmission connection with the second input shaft S12.

As shown in FIG. 6D, the gearwheel of the input/output shaft of the motor EM always meshes with an intermediate gearwheel G5, the intermediate gearwheel G5 always meshes with the gearwheel G22 arranged on the output shaft S2, and the gearwheel G22 always meshes with the gearwheel G12 fixed to the second input shaft S12, so the input/output shaft of the motor EM is always in transmission connection with the second input shaft S12.

In this way, the hybrid power system according to a variant example of the present disclosure illustrated in FIGS. 6A-6D is also capable of implementing the eight operating modes described above and the beneficial effects of the present disclosure.

Specific embodiments of the present disclosure are set forth in detail above, but it should also be noted that:

(i) The hybrid power system according to the present disclosure can be modularly designed to implement a hybrid power module, which may further comprise other components such as a module housing, a cooling jacket, a motor rotor support frame and bearings as required in addition to the components specified above.

(ii) Compared to the hybrid power system comprising a transmission having five synchronous meshing mechanisms, a single clutch and a double clutch described in the background, though the transmission of the hybrid power system according to the present disclosure comprises only three synchronous meshing mechanisms and a double clutch, it is capable of implementing eight pure engine driving modes and ten hybrid power driving modes. In contrast, the hybrid power system according to the present disclosure is simpler in structure, more compact in size, and less costly.

Compared to the hybrid power system comprising a transmission having four synchronous meshing mechanisms and a reverse gear pair described in the background, the transmission of the hybrid power system according to the present disclosure comprises only three synchronous meshing mechanisms and has no dedicated reverse gear pair. In comparison, the hybrid power system according to the present disclosure is simpler in structure, compact in size, and less costly.

Thus, the hybrid power system according to the present invention is capable of employing a large engine, for example, a four-cylinder engine.

(iii) Compared to the structures of the existing hybrid power systems described in the background, the hybrid power system according to the present disclosure, in addition to being simpler in structure, more compact in size, and less costly, is also capable of always achieving no torque interruption during gear shifts, thereby improving driving performance; and the hybrid power system is also capable of optimizing the operating state of the motor for different load configurations and starting the engine smoothly while the vehicle is driven purely by the motor.

(iv) The hybrid power system according to the present disclosure can be applied as a strong hybrid power system and a plug-in hybrid power system, and can be used in various vehicle models.

### LIST OF REFERENCE NUMERALS

ICE engine
K1 first clutch unit
K2 second clutch unit
EM motor
DCT transmission
S11 first input shaft
S12 second input shaft
S2 output shaft
S3 intermediate shaft
G11-G5 gearwheels
A1 first synchronous meshing mechanism
A2 second synchronous meshing mechanism
A3 third synchronous meshing mechanism
DM differential
TI wheels

1. A hybrid power system, comprising:
a transmission comprising a first input shaft, a second input shaft, an output shaft, and an intermediate shaft, the second input shaft sleeves the first input shaft and the second input shaft and the first input shaft are configured for independently rotating respectively;
the output shaft is provided with a first synchronous meshing mechanism and a second synchronous meshing mechanism;
the intermediate shaft is provided with a third synchronous meshing mechanism;
gearwheels corresponding to the first synchronous meshing mechanism always mesh with gearwheels fixed to the second input shaft respectively;
gearwheels corresponding to the second synchronous meshing mechanism always mesh with gearwheels fixed to the first input shaft respectively;
gearwheels corresponding to the third synchronous meshing mechanism always mesh with gearwheels fixed to the first input shaft respectively; and
the intermediate shaft further comprises an intermediate shaft input/output gearwheel fixed thereto, the intermediate shaft input/output gearwheel always meshes with the gearwheels fixed to the second input shaft;
a motor having an input/output shaft that is in driving connection with the second input shaft; and
an engine and a double clutch, wherein the engine is configured to be in driving connection with the first input shaft and the second output shaft via the double clutch.

2. The hybrid power system according to claim 1, wherein the input/output shaft of the motor is directly and coaxially connected with the second input shaft.

3. The hybrid power system according to claim 2, wherein the double clutch is arranged inside of a rotor of the motor.

4. The hybrid power system according to claim 1, wherein
the motor is always in transmission connection with the second input shaft via a gear pair consisting of the gearwheels corresponding to the first synchronous meshing mechanism and the gearwheels fixed to the second input shaft; or
the motor is always in transmission connection with the second input shaft via a gear pair consisting of the intermediate shaft input/output gearwheel and the gearwheels fixed to the second input shaft.

5. The hybrid power system according to claim 1, wherein
while always meshing with the gearwheels corresponding to the second synchronous meshing mechanism, the gearwheels fixed to the first input shaft also always mesh with the gearwheels corresponding to the third synchronous meshing mechanism.

6. The hybrid power system according to claim 1, wherein one of the gearwheels fixed to the second input shaft always meshing with the gearwheels corresponding to the first synchronous meshing mechanism always meshes with the intermediate shaft input/output gearwheel.

7. The hybrid power system according to claim 1, further comprising: a control module configured to control the hybrid power system to separately implement each of a pure motor driving mode, a pure engine driving mode, or a hybrid power driving mode, wherein
when the hybrid power system is in the pure motor driving mode, the engine is in a stopped state, the motor is in an operating state, a first clutch unit and a second clutch unit of the double clutch are both disengaged, and the synchronous meshing mechanisms of the transmission are engaged with the corresponding gearwheels, such that the motor individually transmits torque to the transmission for driving;
when the hybrid power system is in the pure engine driving mode, the engine is in the operating state, the motor is in a stopped state, the first clutch unit or the second clutch unit of the double clutch is engaged, and the synchronous meshing mechanisms of the transmission are engaged with the corresponding gearwheels, such that the engine individually transmits torque to the transmission for driving; or
when the hybrid power system is in the hybrid power driving mode, the engine and the motor are both in the operating state, the first clutch unit or the second clutch unit of the double clutch is engaged, and the synchronous meshing mechanisms of the transmission are engaged with the corresponding gearwheels, such that the engine and the motor transmit torque to the transmission for driving.

8. The hybrid power system according to claim 7, wherein when the hybrid power system is in the pure motor driving mode,
the first synchronous meshing mechanism is engaged with the corresponding gearwheels, and the second synchronous meshing mechanism and the third synchronous meshing mechanism are both in a neutral state of being disengaged from the corresponding gearwheels; or
the first synchronous meshing mechanism is in a neutral state of being disengaged from the corresponding gearwheels, and the second synchronous meshing mechanism and the third synchronous meshing mechanism are engaged with the corresponding gearwheels respectively.

9. The hybrid power system according to claim 7, wherein when the hybrid power system is in the pure engine driving mode,
the first clutch unit is engaged and the second clutch unit is disengaged, the first synchronous meshing mechanism and the third synchronous meshing mechanism are engaged with the corresponding gearwheels respectively, and the second synchronous meshing mechanism is in the neutral state of being disengaged from the corresponding gearwheels; or
the first clutch unit is engaged and the second clutch unit is disengaged, the first synchronous meshing mechanism is engaged with the corresponding gearwheels, and the second synchronous meshing mechanism and the third synchronous meshing mechanism are both in a neutral state of being disengaged from the corresponding gearwheels; or
the first clutch unit is disengaged and the second clutch unit is engaged, the first synchronous meshing mechanism is engaged with the corresponding gearwheels, and the second synchronous meshing mechanism and the third synchronous meshing mechanism are both in the neutral state of being disengaged from the corresponding gearwheels.

10. The hybrid power system according to claim 7, wherein when the hybrid power system is in the hybrid power driving mode,
the first clutch unit is engaged and the second clutch unit is disengaged, the first synchronous meshing mechanism is engaged with the corresponding gearwheels, the second synchronous meshing mechanism is in a neutral state of being disengaged from the corresponding gearwheels, and the third synchronous meshing mechanism is engaged with the corresponding gearwheels; or
the first clutch unit is engaged and the second clutch unit is disengaged, the first synchronous meshing mechanism is engaged with the corresponding gearwheels, the second synchronous meshing mechanism is engaged with the corresponding gearwheels, and the third synchronous meshing mechanism is in a neutral state of being disengaged from the corresponding gearwheels; or
the first clutch unit is disengaged and the second clutch unit is engaged, the first synchronous meshing mechanism is engaged with the corresponding gearwheels, the second synchronous meshing mechanism and the third synchronous meshing mechanism are both in the neutral state of being disengaged from the corresponding gearwheels.

11. The hybrid power system according to claim 7, wherein the hybrid power system is controllable by the control module to implement an idle charge mode,
when the hybrid power system is in the idle charge mode, the engine and the motor are both in the operating state, the first clutch unit of the double clutch is disengaged and the second clutch unit of the double clutch is engaged, and all the synchronous meshing mechanisms of the transmission are in a neutral state of being disengaged from the corresponding gearwheels, such that the engine transmits torque to the motor to enable the motor to charge a battery.

12. The hybrid power system according to claim 7, wherein the hybrid power system is controllable by the control module to implement a start-engine-while-driving mode,
when the hybrid power system is in the start-engine-while-driving mode, the engine and the motor are both in an operating state, the first clutch unit of the double clutch is disengaged and the second clutch unit of the double clutch is engaged, the first synchronous meshing mechanism is engaged with the corresponding gearwheels, and the second synchronous meshing mechanism and the third synchronous meshing mechanism are both in a neutral state of being disengaged from the corresponding gearwheels, such that the motor transmits torque to the transmission while transmitting torque to the engine to start the engine.

13. A hybrid power system, comprising:
a transmission comprising a first input shaft, a second input shaft, an output shaft, and an intermediate shaft, the second input shaft sleeves the first input shaft and the second input shaft and the first input shaft are configured for independently rotating respectively;
the output shaft is provided with a first synchronous meshing mechanism and a second synchronous meshing mechanism;
the intermediate shaft is provided with a third synchronous meshing mechanism;
gearwheels corresponding to the first synchronous meshing mechanism always mesh with gearwheels fixed to the second input shaft respectively;
gearwheels corresponding to the second synchronous meshing mechanism always mesh with gearwheels fixed to the first input shaft respectively;
gearwheels corresponding to the third synchronous meshing mechanism always mesh with gearwheels fixed to the first input shaft respectively; and
the intermediate shaft further comprises an intermediate shaft input/output gearwheel fixed thereto, the intermediate shaft input/output gearwheel always meshes with the gearwheels fixed to the second input shaft;
a motor having an input/output shaft that is in driving connection with the second input shaft; and
an engine and a double clutch, wherein the engine is configured to be in driving connection with the first input shaft and the second output shaft via the double clutch; and
a control module configured to control the hybrid power system to separately implement each of a motor driving mode, an engine driving mode, or a hybrid power driving mode.

14. The hybrid power system according to claim 13, wherein in the motor driving mode, the control module is configured to place the engine is in a stopped state, the motor is in an operating state, a first clutch unit and a second clutch unit of the double clutch in a disengaged state, and the synchronous meshing mechanisms of the transmission in an engaged state with the corresponding gearwheels. such that the motor individually transmits torque to the transmission for driving.

15. The hybrid power system according to claim 13, wherein in the engine driving mode, the control module is configured to place the engine is in an operating state, the motor is in a stopped state, the first clutch unit or the second clutch unit of the double clutch in an engaged state, and the synchronous meshing mechanisms of the transmission in an engaged state with the corresponding gearwheels, such that the engine individually transmits torque to the transmission for driving.

16. The hybrid power system according to claim 13, wherein in the hybrid power driving mode, the control module places the engine and the motor both in an operating state, the first clutch unit or the second clutch unit of the double clutch in an engaged state, and the synchronous meshing mechanisms of the transmission in an engaged state with the corresponding gearwheels, such that the engine and the motor transmit torque to the transmission for driving.
